(19) United States
(12) Patent Application Publication
(10) Pub. No.: US 2024/0312029 A1
(43) Pub. Date: Sep. 19, 2024

(54) Apparatus For Tracking Objects And Method Thereof

(71) Applicants: Hyundai Motor Company, Seoul (KR); Kia Corporation, Seoul (KR)

(72) Inventors: En Sun Lee, Seoul (KR); Hyun Ju Kim, Yongin-Si (KR)

(21) Appl. No.: 18/532,558

(22) Filed: Dec. 7, 2023

(30) Foreign Application Priority Data
Mar. 17, 2023 (KR) 10-2023-0035170

(51) Int. Cl. G06T 7/246; G01S 17/89

(52) U.S. Cl. CPC G06T 7/251; G01S 17/89; G06T 2207/10028

(57) ABSTRACT

There is provided an object tracking apparatus comprising a light detection and ranging (lidar) sensor, one or more processors, and memory storing instructions. The object tracking apparatus receives lidar data from the lidar sensor and track an object using the received lidar data, determine, based on a predetermined criterion and information about the object, at least one of: a first score indicating a likelihood that the object is moving, or a second score indicating a likelihood that the object is stationary, output a comparison result value of a comparison between the first score and the second score, and determine, based on the comparison result value, whether the object is moving or stationary.

### CROSS-REFERENCE TO RELATED APPLICATION

This application claims the benefit of Korean Patent Application No. 10-2023-0035170, filed on Mar. 17, 2023, which is hereby incorporated by reference as if fully set forth herein.

### TECHNICAL FIELD

The present disclosure relates to an object tracking apparatus and method, and more particularly, to an object tracking apparatus and method that may determine a static object using a data grid map.

### BACKGROUND

A light detection and ranging (lidar) sensor may not be able to sense the speed of an object due to the limitations of the lidar sensor, and the speed may be inaccurate when a box variable is large. Accordingly, a typical lidar system had difficulty in determining a dynamic or static object only by speed.

The typical lidar system may determine static objects by combining various characteristic information such as classification and shape information, but may not quickly determine a static object only with shape information because there are various types of static objects on highways and downtown areas.

For example, for bushes/trees, damaged (e.g., cut) guardrails, and the like, shape information may be inaccurate, and thus accurately and quickly determining such objects as static objects may not be easy, and the performance of the lidar system may be degraded because the objects are misrecognized and fast determination is not possible.

### SUMMARY

To solve the technical issues described above, an objective of the present disclosure is to provide an object tracking apparatus and method using a light detection and ranging (lidar) sensor having stable tracking performance by accurately and quickly determining a static object, and a vehicle including the apparatus and a non-transitory recording medium in which a program for executing the method is recorded.

According to one or more example embodiments of the present disclosure, an object tracking apparatus may include: a light detection and ranging (lidar) sensor; and one or more processors; and memory. The memory may store instructions that, when executed by the one or more processors, cause the object tracking apparatus to: receive lidar data from the lidar sensor and track an object using the received lidar data; determine, based on a predetermined criterion and information about the object, at least one of: a first score indicating a likelihood that the object is moving, or a second score indicating a likelihood that the object is stationary; output a comparison result value of a comparison between the first score and the second score; and determine, based on the comparison result value, whether the object is moving or stationary.

The instructions, when executed by the one or more processors, may further cause the object tracking apparatus to: generate at least one grid map to determine whether the object is moving or stationary, and generate a data grid map using the generated at least one grid map.

The instructions, when executed by the one or more processors, may further cause the object tracking apparatus to: match track data of the object with the data grid map; and analyze grid information of at least one grid overlapped with at least one object in a matching map of the track data and the data grid map to determine whether the object is stationary.

The instructions, when executed by the one or more processors, may further cause the object tracking apparatus: based on the analyzed grid information being associated with a value greater than a threshold value, determine that the object is stationary.

The at least one grid map may include a first grid map, a second grid map, and a third grid map. The instructions, when executed by the one or more processors, may further cause the object tracking apparatus to: generate the first grid map using points at a position higher than a predetermined position for determining that the object is stationary; generate the second grid map using lidar point information of the object determined to be stationary; and generate the third grid map using lidar point information of the object determined to be moving.

The instructions, when executed by the one or more processors, may further cause the object tracking apparatus to: generate the data grid map by multiplying or inversely multiplying the first grid map, the second grid map, and the third grid map by weights.

The instructions, when executed by the one or more processors, may further cause the object tracking apparatus to: generate a first data grid map of a current frame by: multiplying a second data grid map of a previous frame by a first weight to yield a first value; multiplying the first grid map by a second weight to yield a second value; multiplying the second grid map by a third weight to yield a third value; and inversely multiplying the third grid map by a sum of the first value, the second value, and the third value.

The instructions, when executed by the one or more processors, may further cause the object tracking apparatus to: analyze a shape of the object by aligning vertex grids of the object in a lateral direction and calculating grids, of the object, ranging from a minimum lateral grid to a maximum lateral grid.

The instructions, when executed by the one or more processors, may further cause the object tracking apparatus to: classify, based on vertices of a shape of the object, the shape of the object into a first type, a second type, a third type, or a fourth type.

The instructions, when executed by the one or more processors, may further cause the object tracking apparatus to: classify, based on vertices of a shape of the object, the shape of the object into a first type, a second type, a third type, or a fourth type; and divide each of the first type, the second type, the third type, and the fourth type into at least one area.

According to one or more example embodiments of the present disclosure, a method may include: receiving, from a light detection and ranging (lidar) sensor, lidar data associated with an object; determining, based on a predetermined criterion and the lidar data, at least one of: a first score indicating a likelihood that the object is moving, or a second score indicating a likelihood that the object is stationary; outputting a comparison result value of a comparison between the first score and the second score; and determining, based on the comparison result value, whether the object is moving or stationary.

The method may further include: generating at least one grid map to determine whether the object is moving or stationary, and generating a data grid map using the generated at least one grid map.

The method may further include: matching track data of the object with the data grid map; and analyzing grid information of at least one grid overlapped with at least one object in a matching map of the track data and the data grid map to determine whether the object is stationary.

The method may further include: based on the analyzed grid information being associated with a value greater than a threshold value, determining that the object is stationary.

The at least one grid map may include a first grid map, a second grid map, and a third grid map. The method may further include: generating the first grid map using points at a position higher than a predetermined position for determining that the object is stationary; generating the second grid map using lidar point information of the object determined to be stationary; and generating the third grid map using lidar point information of the object determined to be moving.

The method may further include: generating the data grid map by multiplying or inversely multiplying the first grid map, the second grid map, and the third grid map by weights.

The method may further include: generating a first data grid map of a current frame by: multiplying a second data grid map of a previous frame by a first weight to yield a first value; multiplying the first grid map by a second weight to yield a second value; multiplying the second grid map by a third weight to yield a third value; and inversely multiplying the third grid map by a sum of the first value, the second value, and the third value.

The method may further include: analyzing a shape of the object by aligning vertex grids of the object in a lateral direction and calculating grids, of the object, ranging from a minimum lateral grid to a maximum lateral grid.

The method may further include: classifying, based on vertices of a shape of the object, the shape of the object into a first type, a second type, a third type, or a fourth type.

The method may further include: classifying, based on vertices of a shape of the object, the shape of the object into a first type, a second type, a third type, or a fourth type; and
dividing each of the first type, the second type, the third type, and the fourth type into at least one area.

### BRIEF DESCRIPTION OF THE DRAWINGS

FIG. 1 is a flowchart illustrating an object tracking method using a light detection and ranging (lidar) sensor according to an embodiment of the present disclosure.

FIG. 2 is a block diagram illustrating an object tracking apparatus using a lidar sensor according to an embodiment of the present disclosure.

FIGS. 3A, 3B, and 3C are diagrams illustrating examples of a format of data (i.e., segment box information) processed by an object tracking unit (e.g., an object tracking unit 640).

FIG. 4 is a block diagram illustrating an object tracking unit according to an embodiment of the present disclosure.

FIG. 5 is a diagram illustrating a grid map generator according to an embodiment of the present disclosure.

FIGS. 6A, 6B, 6C, and 6D are diagrams illustrating a grid map generated as described with reference to FIG. 5.

FIGS. 7, 8, 9, 10, 11A, 11B, 11C, 11D, and 12 are diagrams illustrating a static object determiner and a method thereof according to an embodiment of the present disclosure.

FIGS. 13A, 13B, 13C, 13D, 14A, 14B, 14C, 15A, 15B, 15C, 16A, 16B, 16C, 17A, 17B, 17C, 18A, 18B, 18C, 19A, 19B, 19C, 20A, 20B, and 20C show result values according to various embodiments of the present disclosure.

FIG. 21 shows an example table of features, weights, and scores.

### DETAILED DESCRIPTION OF THE DISCLOSURE

Hereinafter, embodiments of the present disclosure will be described in detail with reference to the accompanying drawings, and the same or similar elements will be given the same reference numerals regardless of reference symbols, and redundant description thereof will be omitted.

In the description of the embodiments, when it is described as formed “on/above” or “under/below” an element, it may be construed that two elements are in direct contact, or the two elements are in indirect contact with one or more other elements disposed therebetween.

In addition, when it is described as “up/above” or “down/below,” such expressions may include both an upward direction and a downward direction with respect to an element.

In addition, relational terms such as “first” and “second,” and “on/above/up/upper” and “under/below/lower” used herein may not necessarily refer to any physical or logical relationship between such entities or elements. Alternatively, they may be used to distinguish one entity or element from another entity or element, without necessarily requiring or implying an order therebetween.

Hereinafter, an object tracking method and apparatus 600 using a light detection and ranging (lidar) sensor 500 according to an embodiment and a vehicle 1000 using the same will be described with reference to the accompanying drawings.

For convenience, the object tracking method and device 600 using the lidar sensor 500 and the vehicle 1000 using the same will be described hereinafter using the Cartesian coordinate system (x-axis, y-axis, and z-axis), but other coordinate systems may also be used. In addition, according to the Cartesian coordinate system, the x-axis, y-axis, and z-axis are orthogonal to each other, but examples are not limited thereto. That is, the x-axis, y-axis, and z-axis may cross each other.

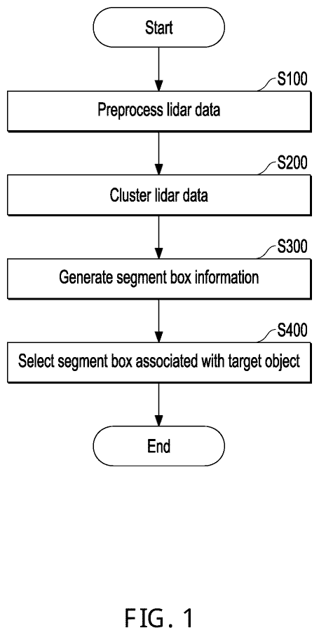

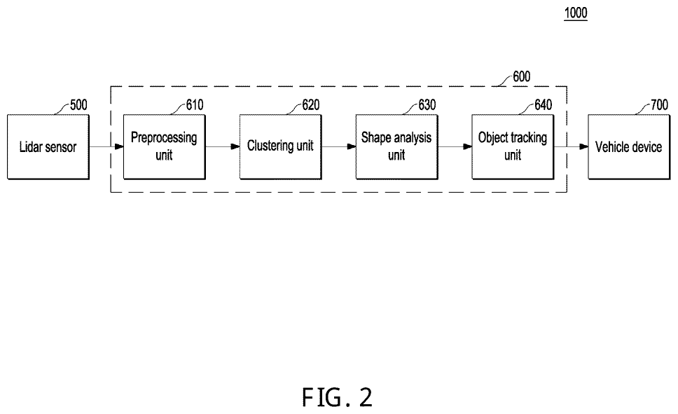

FIG. 1 is a flowchart illustrating an object tracking method using a lidar sensor according to an embodiment, and FIG. 2 is a block diagram illustrating an object tracking apparatus using a lidar sensor according to an embodiment.

For the convenience of description, the object tracking method shown in FIG. 1 will be described as performed by the object tracking apparatus 600 shown in FIG. 2, but examples are not limited thereto. That is, according to another embodiment, the object tracking method shown in FIG. 1 may be performed by an object tracking apparatus having a configuration different from that of the object tracking apparatus 600 shown in FIG. 2.

In addition, the object tracking apparatus 600 shown in FIG. 2 will be described as performing the object tracking method shown in FIG. 1, but examples are not limited thereto. That is, according to another embodiment, the object tracking apparatus 600 shown in FIG. 2 may perform an object tracking method having a configuration different from that of the object tracking method shown in FIG. 1.

The object tracking apparatus 600 using a lidar sensor 500 shown in FIG. 2 may include a preprocessing unit 610, a clustering unit 620, a shape analysis unit 630, and an object tracking unit 640. The shape analysis unit 630 may also be referred to as a segment unit. The object tracking unit 640 may also be referred to as a tracking unit, a tracking and classification unit, or an object detection unit.

In addition, a vehicle 1000 according to an embodiment may include the lidar sensor 500, the object tracking apparatus 600, and a vehicle device 700.

### Lidar Sensor

The lidar sensor 500 may emit, for example, a circular single laser pulse having a wavelength of 905 nm to 1550 nm to an object, and then measure a time for which the laser pulse reflected from the object within a measurement range returns to sense information about the object, such as a distance from the sensor 500 to the object, a direction of the object, a speed, a temperature, a material distribution, and a concentration property.

The object described herein may be another vehicle, a person, a thing, and the like present outside the vehicle 1000 (hereinafter also referred to as a “host vehicle”) including the lidar sensor 500, but the object is not limited to a specific type of object.

The lidar sensor 500 may include a transmitter (not shown) configured to transmit a laser pulse and a receiver (not shown) configured to receive a laser reflected back from the surface of an object present within a sensor range. The receiver may have a field of view (FOV), which is an area that is observable at once by the lidar sensor 500 without movement or rotation.

The lidar sensor 500 has a higher longitudinal/lateral sensing accuracy compared to a radio detecting and ranging (radar) sensor, and may thus provide accurate longitudinal/lateral position information, thereby being readily used for obstacle detection and vehicle position recognition.

As the lidar sensor 500, there are a two-dimensional (2D) lidar sensor and a three-dimensional (3D) lidar sensor. The 2D lidar sensor may be configured to be tilted or rotatably moved and may be used to obtain lidar data including 3D information as tilted or rotated. The 3D lidar sensor may obtain a plurality of 3D points and may thus predict even height information of an obstacle, assisting in accurate and precise object detection or tracking. The 3D lidar sensor may include the 2D lidar sensor formed as a plurality of layers to generate lidar data including 3D information.

The lidar sensor 500 may output point cloud data (hereinafter referred to as “lidar data”) including a plurality of points for a single object. The point cloud data may also be referred to as lidar point cloud data.

The object tracking apparatus 600 and its method according to embodiments are not limited to a specific shape, position, and type of the lidar sensor 500.

### Object Tracking

On the other hand, the object tracking apparatus 600 may receive lidar data, and use the lidar data to detect the presence or absence of an object; start, suspend, or stop tracking the object; update, store, or delete information about the object; and further classify a type of object.

In addition, the object tracking apparatus 600 may manage a final object by fusing an object result detected in the process of tracking the object with previous object information, and select the shape, position, speed, and heading of the final object and finally synthesize all the information to determine a moving/stationary state.

When determining the moving/stationary state, the object tracking apparatus 600 may first determine whether an object is a dynamic (e.g., moving) object or a static object, and may determine the moving/stationary state using speed information in response to the object being the dynamic object, and determine the stationary state in response to the object being the static object.

### Preprocessing Unit

The preprocessing unit 610 may preprocess lidar data (S100). For example, the preprocessing unit 610 may perform calibration to align coordinates between the lidar sensor 500 and the vehicle 1000. That is, the lidar sensor 500 may convert the lidar data according to a reference coordinate system based on a position angle at which the lidar sensor 500 is provided in the vehicle 1000. In addition, the preprocessing unit 610 may remove points having low intensity or reflectance through filtering, using intensity or confidence information of the lidar data.

In addition, the preprocessing unit 610 may remove data reflected by a vehicle body of the host vehicle 1000. That is, there is an area hidden by the vehicle body of the host vehicle 1000 according to a mounting position and a FOV of the lidar sensor 500, and thus the preprocessing unit 610 may remove data reflected from the vehicle body of the host vehicle 1000 using the reference coordinate system.

In the object tracking method according to an embodiment of the present disclosure, step S100 of FIG. 1 may be omitted and, in this case, the preprocessing unit 610 may be omitted from the object tracking apparatus 600 according to an embodiment of the present disclosure.

### Clustering

After step S100, the clustering unit 620 may group the point cloud data, which is lidar data including a plurality of points for an object obtained through the lidar sensor 500, into meaningful units according to predetermined rules (S200). When the preprocessing step S100 and the preprocessing unit 610 are not omitted, the clustering unit 620 may group lidar data preprocessed by the preprocessing unit 610. For example, the clustering unit 620 may group lidar data by applying vehicle modeling or guardrail modeling to cluster an outer shape of the object. A result sensed by the lidar sensor 500 may correspond to a plurality of points, and each point may only have positional information. Accordingly, the clustering unit 620 may serve to group a plurality of points sensed by the lidar sensor 500 into meaningful shape units.

For example, as a type of clustering unit 620, there are 2D clustering and 3D clustering. The 2D clustering, which performs clustering by projecting data onto the X-Y plane without considering height information, may perform clustering in point units or specific structured units. The 3D clustering may perform clustering on the X-Y-Z plane by considering all height information (Z).

### Geometric Analysis (Segment)

After step S200, the shape analysis unit 630 may generate information on a plurality of segment boxes for each channel using a clustering result obtained from the clustering unit 620 (S300). A segment box described herein may refer to a result of transforming the clustering result into a geometric box shape. Also, segment box information described herein may refer to at least one of the width, length, position, or direction (or heading) of a segment box. A channel will be described in detail below.

The description of step S400 according to an embodiment described below is not limited to the presence or absence of step S100, the preprocessing process in step S100, the clustering process in step S200, and the method of performing a specific process in the process of generating segment box information in step S300. Similarly, the description of the object tracking unit 640 according to an embodiment described below is not limited to the presence or absence of the preprocessing unit 610, and a specific type of operation performed in each of the preprocessing unit 610, the clustering unit 620, and the shape analysis unit 630. That is, even when the preprocessing unit 610 is omitted (i.e., step S100 is omitted), the preprocessing unit 610 performing step S100 processes lidar data differently from what has been described above, the clustering unit 620 performing step S200 clusters lidar data differently from what has been described above, the shape analysis unit 630 performing step S300 generates segment box information differently from what has been described above, step S400 and the object tracking unit 640 according to an embodiment may still be applicable.

### Object Tracking

After step S300, the object tracking unit 640 may select a segment box (or, a “final segment box” or an “associated segment box”) associated with an object that is being tracked (hereinafter a “target object”) at a current time t from among a plurality of segment boxes for each channel (S400). Here, “associated” or “association” described herein may refer to a process of selecting a box to be used to maintain tracking of a target object that is currently being tracked, from among a plurality of segment boxes that may be obtained for the same object according to the visibility of the lidar sensor 500 and the shape of the object. The association may be performed every cycle.

To select an associated segment box from each of a plurality of segment boxes provided for each channel from the shape analysis unit 630, the object tracking unit 640 may transform information on each of the plurality of segment boxes into a preset format, and select the associated segment box from among a plurality of segment boxes (or segment boxes of a meta object) having the transformed format.

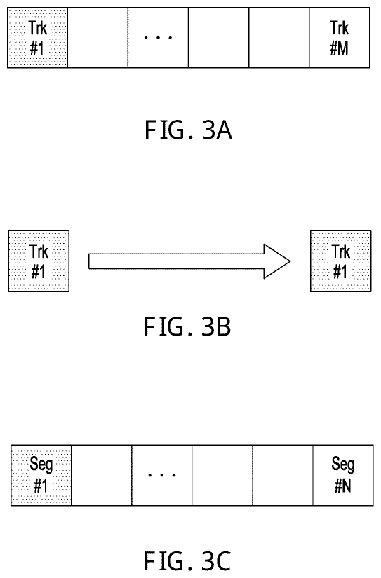

FIGS. 3A, 3B, and 3C are diagrams illustrating examples of a format of data (i.e., segment box information) processed by an object tracking unit.

According to an embodiment, the object tracking apparatus 600 may track M target objects. Here, M denotes a positive integer greater than or equal to 1. That is, the number M of target objects that may be tracked is the number M of tracks (trk) shown in FIG. 3A. In addition, a unit in which history information on a unit target object is preserved may be referred to as a “channel,” and the number of channels is equal to the number of tracks (trk).

In this case, the history information may be information accumulated before a current time point t for a target object being tracked in each channel, for example, position information and speed information of the target object by time slot.

In addition, N segment boxes (seg #1 to seg #N) for a unit target object may be generated by the shape analysis unit 630 and provided to the object tracking unit 640 at the current time point t. Here, N is a positive integer greater than or equal to 1 and may be the same as or different from M. Hereinafter, N is described as a positive integer of 2 or greater, but the following description may be applied even when N is 1. That is, as shown in FIG. 3C, N segment boxes (seg #1 to seg #N) may be present in each (trk #m) of first to M-th channels (trk #1 to trk #M) (here, 1≤m≤M).

The object tracking unit 640 may select an associated segment box at a current time point t for a target object that is currently being tracked in each channel from among N segment boxes (seg #1 to seg #N) belonging to each of first to M-th channels (S400).

Hereinafter, for the convenience of description, a process of selecting an associated segment box at a current time point t for a target object that is currently being tracked in an m-th channel (Trk #m) from among N segment boxes (seg #1 to seg #N) as shown in FIG. 3A will be described, but the following description may also be applied to a process of selecting an associated segment box at the current time point t for the target object that is currently being tracked from among N segment boxes (seg #1 to seg #N) belonging to each of other channels.

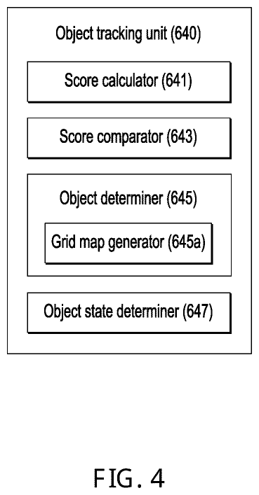

FIG. 4 is a block diagram illustrating an object tracking unit according to an embodiment of the present disclosure.

Referring to FIG. 4, the object tracking unit 640 may include a score calculator 641, a score comparator 643, an object determiner 645, and an object state determiner 647.

The score calculator 641 may calculate a dynamic score (e.g., moving object score) for a dynamic (e.g., moving) object and a static score (e.g., stationary object score) for a static (e.g., stationary) object according to a preset rule, using information on the speed, classification, shape, heading, and the like of an object.

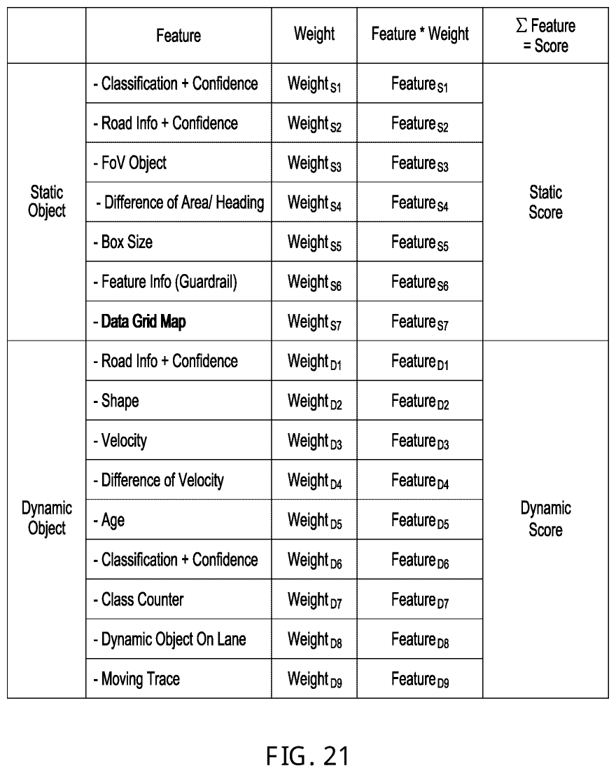

The score calculator 641 may extract features that determine the static object and features that determine the dynamic object, and assign different weights corresponding to the respective features according to the importance of the extracted features that determine the static object and the dynamic object. As shown in FIG. 21, based on features, weights, and feature×weight, the static object and the dynamic object may respectively have the static score that is obtained by adding all scores of the features and feature scores of the static object and the dynamic score that is obtained by adding all feature scores of the dynamic object.

The static object and the dynamic object may each have one or more features. For example, the features of a static object may include Classification+Confidence, Road Info+Confidence, FOV Object, Difference of Area/Heading, Box Size, Feature Info (Guardrail), Data Grid Map, and the like. The features of a dynamic object may include Road Info+Confidence, Shape, Velocity, Difference of Velocity, Age, Classification+Confidence, Class Counter, Dynamic On Lane, Moving Trace, and the like.

The score comparator 643 may compare the dynamic score and the static score calculated by the score calculator 641. The score comparator 643 may output or transmit a comparison result value.

The object determiner 645 may determine an object type, for example, whether the object is a dynamic object or a static object (Dynamic/Static) according to the score comparison result provided by the score comparator 643.

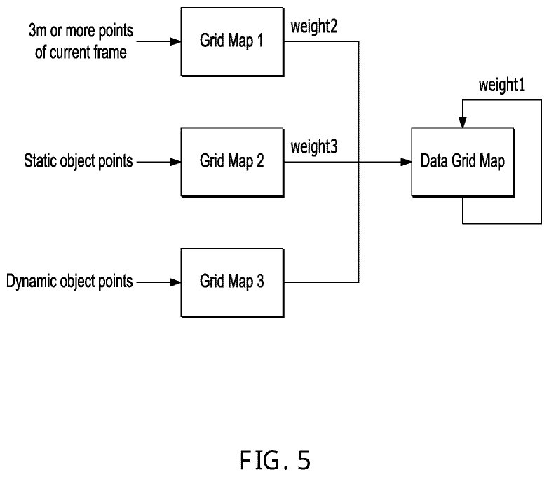

The object determiner 645 may include a grid map generator 645a. The grid map generator 645a may include at least one grid map, and may generate a data grid map based on the grid map and determine an object type using the generated data grid map. This will be described in detail below with reference to FIG. 5.

The object state determiner 647 may receive a determination result value of the object determiner 645 and finally determine whether the object is a static object or a dynamic object. For example, when the determination result value corresponds to a dynamic object, the object state determiner 647 may determine whether the object is in a moving state or a stationary state. In addition, when the determination result value corresponds to a static object, the object state determiner 647 may determine the stationary state.

The object state determiner 647 may match the data grid map generated by the grid map generator 645a to track data, and when the matched grid information is greater than a preset reference range, determine a static object. This will be described in detail below.

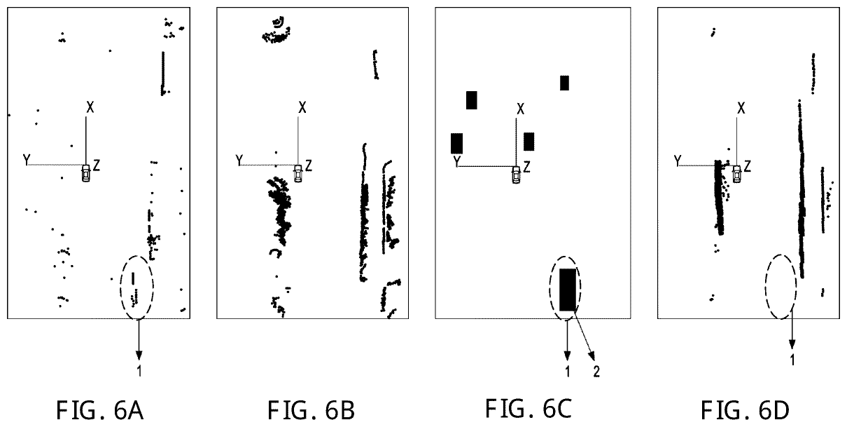

FIG. 5 is a diagram illustrating a grid map generator according to an embodiment of the present disclosure. FIGS. 6A, 6B, 6C, and 6D are diagrams illustrating a grid map generated as described with reference to FIG. 5.

Referring to FIG. 5, the grid map generator 645a may generate at least one grid map and a data grid map under the control of the object determiner 645.

The at least one grid map may include a first grid map, a second grid map, and a third grid map.

As shown in FIG. 6A, the grid map generator 645a may generate the first grid map (Grid Map 1) using a point at a position higher than a preset position to determine a static object such as a bush/tree or a noise barrier. For example, the grid map generator 645a may generate the first grid map (Grid Map 1) by projecting lidar point information having a higher altitude than a preset position among all lidar points of a current frame onto the X-Y plane, and then by approximating it with a specific resolution. The preset position may be set to approximately 2 meters (m). For example, the grid map generator 645a may generate the first grid map based on information on lidar points located at 3 to 4.5 m, which is greater than the preset position of 2 m. In this case, the grid map generator 645a may generate the first grid map based on information on lidar points located lower than 5 m to exclude a road sign.

As shown in FIG. 6B, the grid map generator 645a may generate the second grid map (Grid Map 2) using lidar point information of an object determined as a static object. For example, the grid map generator 645a may generate the second grid map (Grid Map 2) by projecting lidar point information of a track object determined as a static object through history information generated through the object tracking unit 640 onto the X-Y plane, and then by approximating it with a specific resolution.

As shown in FIG. 6C, the grid map generator 645a may generate the third grid map (Grid Map 3) using lidar point information of an object determined as a dynamic object.

For example, the grid map generator 645a may generate the third grid map (Grid Map 3) by projecting lidar point information of a track object determined as a dynamic object through history information generated through the object tracking unit 640 onto the X-Y plane, and then by approximating it with a specific resolution.

As shown in FIG. 6D, the grid map generator 645a may generate the data grid map using the first grid map, the second grid map, and the third grid map.

The grid map generator 645a may generate the data grid map by multiplying or inversely multiplying (i.e., inverse product) the first grid map, the second grid map, and the third grid map, by weights. The data grid map may be referred to as a final data grid map.

For example, the grid map generator 649 may multiply data grid map of a previous frame by a first weight (weight 1), multiply the first grid map by a second weight (weight 2), and multiply the second grid map by a third weight (weight 3), and then add the result values obtained by the multiplying and inversely multiply the third grid map by a result value of the adding, to generate a data grid map of a current frame. This may be represented by Equation 1 below.

$$[ Equation 1 ]$$

$$Data Grid Map = ( Data Grid Map \times weight 1 + Grid Map 1 \times weight 2 + Grid Map 2 \times weight 3 ) \times ( Grid Map {3}^{′} ( inverse ) )$$

That is, after multiplying the first grid map (Grid Map 1), the second grid map (Grid Map 2), and the data grid map (Data Grid Map) of the previous frame by the weights, and adding result values obtained therefrom (i.e., a weighted sum), and then inversely multiplying (i.e., an inverse product) the third grid map (Grid Map 3), a final data grid map of the current frame may be calculated.

To prevent a case where a dynamic object such as a truck is determined as a static object as the first grid map (Grid Map 1) is generated due to 3 m or greater lidar point information, the grid map generator 645a may generate the third grid map based on the dynamic object and then calculate an inverse product to reduce an error.

For example, for a bus 1, points of 3 m or more exist and the first grid map (Grid Map 1) is generated as shown in FIG. 6A, while, for a truck 2 determined as a dynamic object, the third grid map (Grid Map 3) is generated based on history information as shown in FIG. 6C and final data grid map does not represent it by an inverse product of the third grid map (Grid Map 3) as shown in FIG. 6D.

In addition, the data grid map may be rotated and transformed according to the behavior of a host vehicle every frame under the control of the grid map generator 645a.

The data grid map may be accumulated up to n times under the control of the grid map generator 645a. In this case, n may be a natural number greater than or equal to 1.

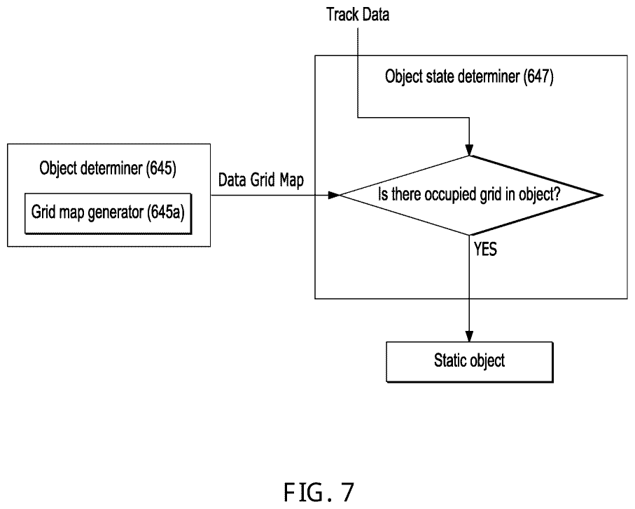

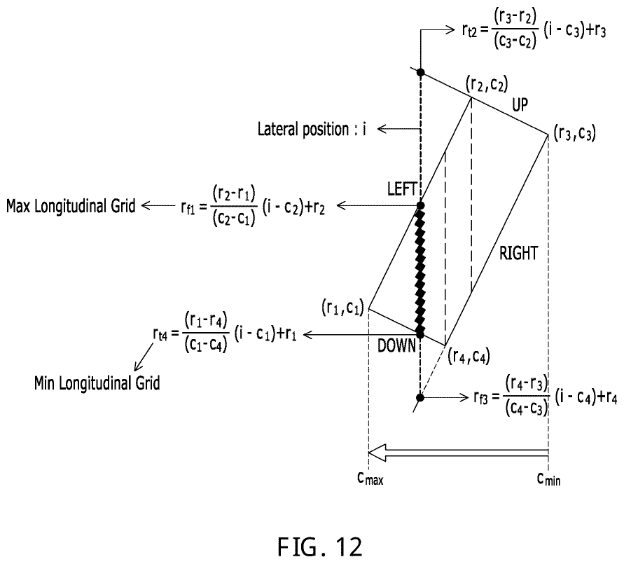

FIGS. 7, 8, 9, 10, 11A, 11B, 11C, 11D, and 12 are diagrams illustrating an object determination unit and a method thereof according to an embodiment of the present disclosure.

Referring to FIG. 7, the object state determiner 647 according to an embodiment of the present disclosure may match a data grid map generated by the grid map generator 645a to track data provided by the object tracking unit 640. In addition, the object state determiner 647 may analyze grid information overlapping at least one object in the matched matching map, and determine whether an object is a static object based on the analyzed result value. For example, the object state determiner 647 may analyze the grid information occupying the at least one object in the matched matching map, and when the analyzed grid information is greater than a preset grid threshold value, the object may be determined as a static object, and a score may be assigned.

Here, track data may be transformed into a track grid under the control of the object state determiner 647 and then matched to a data grid map.

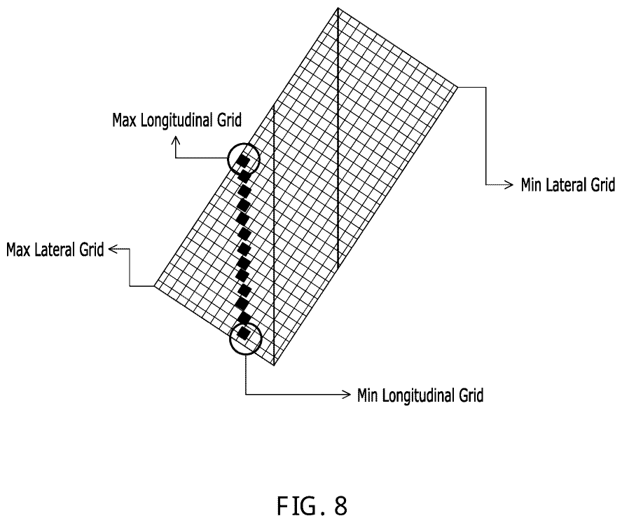

The object state determiner 647 may express the grid information overlapping the at least one object in the matched matching map as shown in FIG. 8. In FIG. 8, the object is shown as a box to facilitate the description, but is not limited thereto.

The object state determiner 647 may analyze grid information from a maximum longitudinal grid (max longitudinal grid) to a minimum longitudinal grid (min longitudinal grid) at a lateral position while moving in a lateral direction from a minimum lateral grid (min lateral grid) to a maximum lateral grid (max lateral grid) based on one generated object.

In this case, the object state determiner 647 may repeat the foregoing analysis operation at all lateral positions.

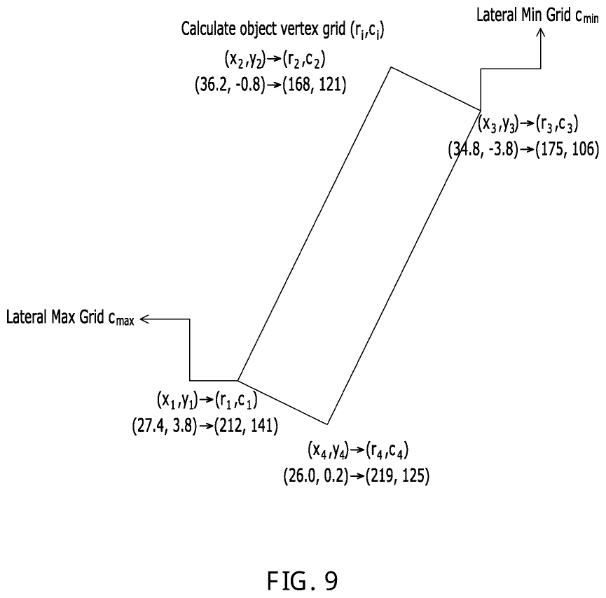

As shown in FIGS. 9, 10, 11A, 11B, 11C, 11D, and 12, the object state determiner 647 may analyze grid information from the maximum longitudinal grid to the minimum longitudinal grid at a current lateral position, as follows.

First, as shown in FIG. 9, the object state determiner 647 may transform vertices of an object into a grid. For example, the object state determiner 647 may transform (x, y) into (r, c). That is, Row (r₁)=(Grid×Size−x₁)*Grid Resolution, Column (c₁)=(Grid Y Size+y₁)*Grid Resolution.

Subsequently, the object state determiner 647 may align the object vertex grid laterally, calculate grids from a minimum lateral grid to a maximum lateral grid of the object, and identify the shape of the object.

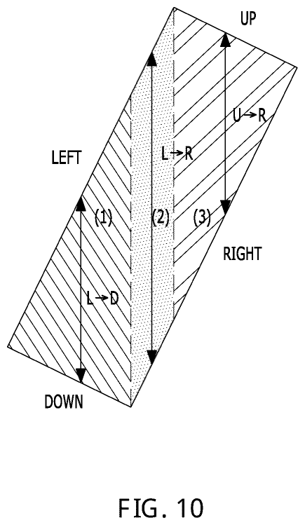

Also, as shown in FIG. 10, the object state determiner 647 may divide the identified shape of the object into at least one area.

The object state determiner 647 may analyze grid information from a maximum longitudinal grid to a minimum longitudinal grid for each of one or more divided areas, as follows.

First, the object state determiner 647 may divide the shape of an object into at least one area. For example, the object state determiner 647 may divide the shape of the object into a first area, a second area, and a third area. However, examples are not limited thereto.

For example, as shown in FIG. 10, the first area may have a maximum longitudinal grid formed on a left side (Left) and a minimum longitudinal grid formed on a lower side (Down).

The second area may have a maximum longitudinal grid formed on the left side and a minimum longitudinal grid formed on a right side (Right).

The third area may have a maximum longitudinal grid formed on an upper side (Up) and a minimum longitudinal grid formed on the right side.

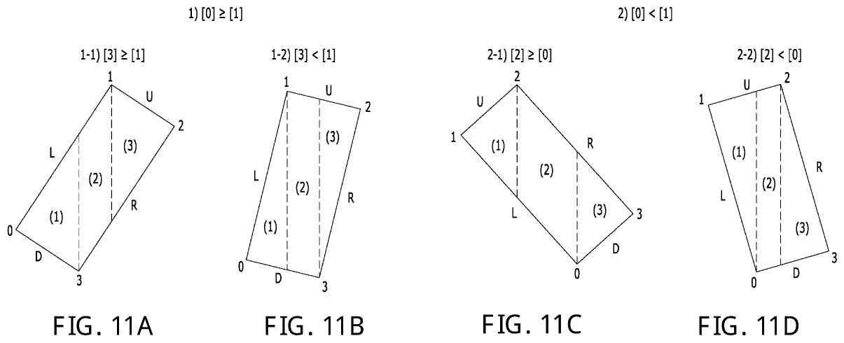

The object state determiner 647 may also divide the shape of the object in various ways. For example, the object state determiner 647 may divide the shape as shown in FIGS. 11A, 11B, 11C, and 11D.

For example, under the assumption that respective vertices of the shape of an object are 0, 1, 2, and 3, the object state determiner 647 may form vertex 0 on a left side of the bottom of the shape of the object, vertex 1 on a left side of the top of the shape of the object, vertex 2 on a right side of the top of the shape of the object, and vertex 3 on a right side of the bottom of the shape of the object.

As shown in FIG. 11A, the object state determiner 647 may express [0]≥[1] when vertex 0 is disposed further leftward than vertex 1, and express [3]≥[1] when vertex 3 is disposed further leftward than vertex 1.

[0]≥[1] and [3]≥[1] are defined herein as a first type. The first type may be divided into first to third areas as follows, and each area may have a maximum longitudinal grid and a minimum longitudinal grid expressed as follows.

The first area of the first type may have a maximum longitudinal grid formed on a left side (Left) and a minimum longitudinal grid formed on a lower side (Down).

The second area of the first type may have a maximum longitudinal grid formed on a left side (Left) and a minimum longitudinal grid formed on a right side (Right).

The third area of the first type may have a maximum longitudinal grid formed on an upper side (Up) and a minimum longitudinal grid formed on a right side (Right).

As shown in FIG. 11B, the object state determiner 647 may express [0]≥[1] when vertex 0 is disposed further leftward than vertex 1, and express [3]≤[1] when vertex 3 is disposed further rightward than vertex 1.

[0]≥[1] and [3]≤[1] are defined herein as a second type. The second type may be divided into first to third areas as follows, and each area may have a maximum longitudinal grid and a minimum longitudinal grid expressed as follows.

The first area of the second type may have a maximum longitudinal grid formed on a left side (left) and a minimum longitudinal grid formed on a lower side (Down).

The second area of the second type may have a maximum longitudinal grid formed on an upper side (Up) and a minimum longitudinal grid formed on a lower side (Down).

The third area of the second type may have a maximum longitudinal grid formed on an upper side (Up) and a minimum longitudinal grid formed on a right side (Right).

As shown in FIG. 11C, the object state determiner 647 may express [0]≤[1] when vertex 0 is disposed further rightward than vertex 1, and express [2]≥[0] when vertex 2 is disposed further leftward than vertex 0.

[0]≤[1] and [2]≥[0] are defined herein as a third type. The third type may be divided into first to third areas as follows, and each area may have a maximum longitudinal grid and a minimum longitudinal grid expressed as follows.

The first area of the third type may have a maximum longitudinal grid formed on an upper side (Up) and a minimum longitudinal grid formed on a left side (Left).

The second area of the third type a maximum longitudinal grid formed on a right side (Right) and a minimum longitudinal grid formed on a left side (Left).

The third area of the third type may have a maximum longitudinal grid formed on a right side (Right) and a minimum longitudinal grid formed on a lower side (Down).

As shown in FIG. 11D, the object state determiner 647 may express [0]≤[1] when vertex 0 is disposed further rightward than vertex 1, and express [2]≤[0] when vertex 2 is disposed further rightward than vertex 0.

[0]≤[1] and [2]≤[0] are defined herein as a fourth type. The fourth type may be divided into first to third areas as follows, and each area may have a maximum longitudinal grid and a minimum longitudinal grid expressed as follows.

The first area of the fourth type may have a maximum longitudinal grid formed on an upper side (Up) and a minimum longitudinal grid formed on a left side (Left).

The second area of the fourth type may have a maximum longitudinal grid formed on an upper side (Up) and a minimum longitudinal grid formed on a lower side (Down).

The third area of the fourth type may have a maximum longitudinal grid formed on a right side (Right) and a minimum longitudinal grid formed on a lower side (Down).

As described above, the object state determiner 647 may calculate longitudinal grids of all sides at a current lateral position i using an object vertex (r, c) and the equation of a straight line passing through the two points. In this case, the equation of the straight line may be expressed as Equation 2 below.

$${r}_{i , j} = \frac{( {r}_{k} - {r}_{j} )}{( {c}_{k} - {c}_{j} )} ( i - {c}_{k} ) + {r}_{k} \qquad [ Equation 2 ]$$

The object state determiner 647 may calculate at least four longitudinal grids using an object vertex (r, c) and the like. For example, the object state determiner 647 may extract a longitudinal grid that exists inside or overlaps an object among the four longitudinal grids. That is, the object state determiner 647 may ignore or delete a longitudinal grid that exists outside the object without extracting it.

Subsequently, the object state determiner 647 may extract a maximum longitudinal grid and a minimum longitudinal grid from longitudinal grids present in an object. The object state determiner 647 may then repeat the foregoing process from a minimum lateral grid (cₘᵢₙ) to a maximum lateral grid (cₘₐₓ) at a lateral position i.

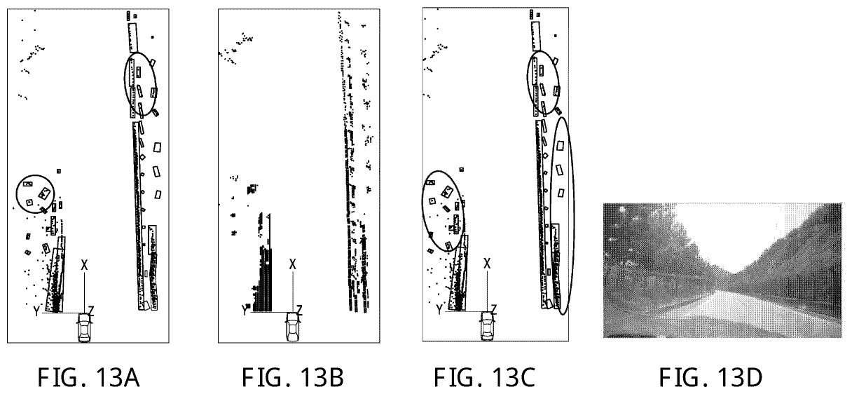

FIGS. 13A, 13B, 13C, 13D, 14A, 14B, 14C, 15A, 15B, 15C, 16A, 16B, 16C, 17A, 17B, 17C, 18A, 18B, 18C, 19A, 19B, 19C, 20A, 20B, and 20C show result values obtained from experiments performed using an object tracking apparatus and its method according to various embodiments of the present disclosure.

FIG. 13A shows track data, FIG. 13B shows a final data grid map, FIG. 13C shows a matching between the track data and the final data grid map, and FIG. 13D shows a real captured image.

As shown in FIG. 13A, when using only track data, the object tracking unit may not readily determine fast a static object because shape information such as a bush/tree and a cut guardrail is not accurate.

As shown in FIG. 13B, the object tracking unit may generate a final data grid map by multiplying a first grid map, a second grid map, and a third grid map by weights, or obtaining an inverse product.

As shown in FIG. 13C, the object tracking unit may match the track data and the final grid map to determine an object as a static object (red circle) through a grid occupied in the object.

As shown in FIGS. 13A, 13B, 13C, and 13D, the object tracking unit may quickly determine even a static object with inaccurate shape information such as a bush/tree and a cut guardrail, using a grid map.

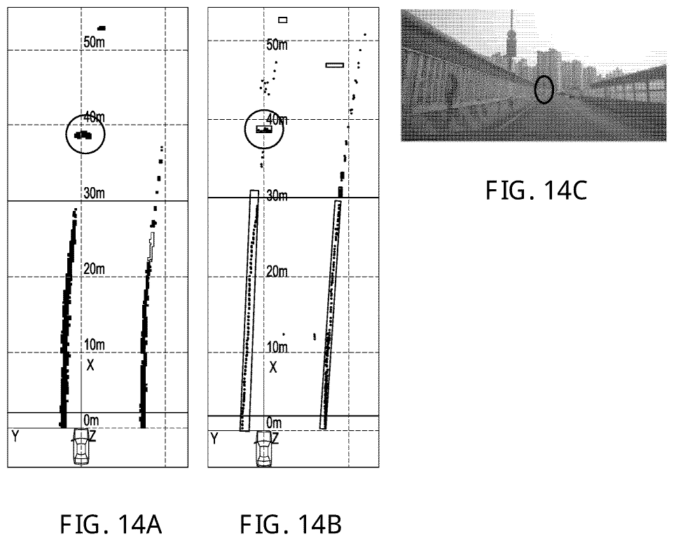

Referring to FIGS. 14A, 14B, and 14C, on a curved road, a road sign present inside a road boundary and having a similar shape to a vehicle may be misrecognized as a dynamic object.

FIG. 14A shows a final data grid map, FIG. 14B shows a matching between track data and the final data grid map, and FIG. 14C shows a real captured image.

As shown in FIGS. 14A and 14B, the object tracking unit may generate a data grid map through points at a high position for an object (e.g., a road sign), and determine the object (road sign) as a static object using the generated grid map.

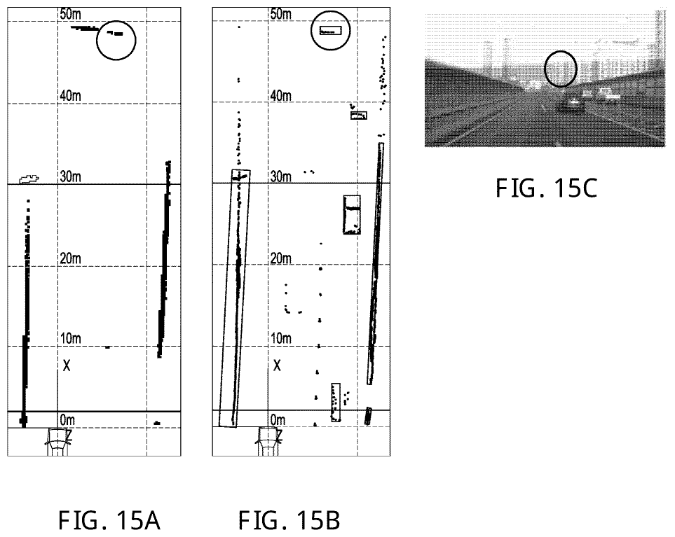

Referring to FIGS. 15A, 15B, and 15C, on a merging road, a road sign present inside a road boundary and having a similar shape to a vehicle may be misrecognized as a dynamic object.

FIG. 15A shows a final data grid map, FIG. 15B shows a matching between track data and the final data grid map, and FIG. 15C shows a real captured image.

As shown in FIGS. 15A and 15B, the object tracking unit may generate a data grid map through points at a high position for an object (e.g., a road sign) and determine the object (road sign) as a static object using the generated grid map.

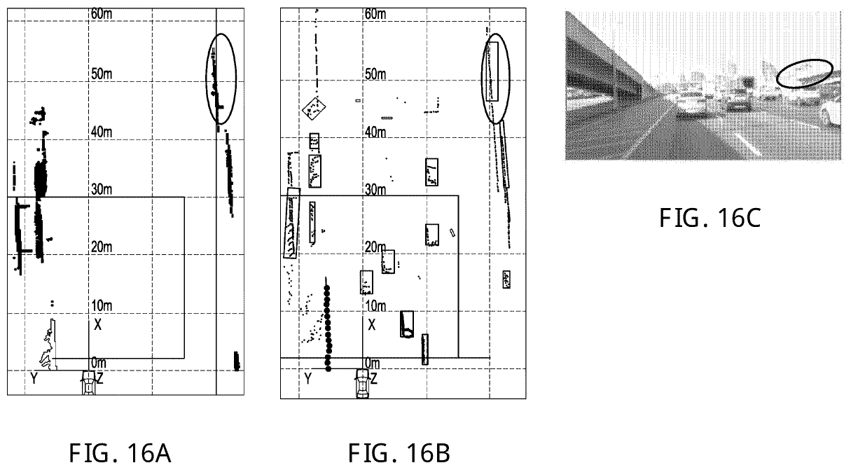

Referring to FIGS. 16A, 16B, and 16C, a guardrail that is hidden by a nearby vehicle and is thus cut off may be misrecognized as a dynamic object as it moves at a constant speed and in a constant direction along with the vehicle.

FIG. 16A shows a final data grid map, FIG. 16B shows a matching between track data and the final data grid map, and FIG. 16C shows a real captured image.

As shown in FIGS. 16A and 16B, the object tracking unit may generate a data grid map of an object (e.g., a cut guardrail) through points at a high position and determine the object (cut guardrail) as a static object using the generated grid map.

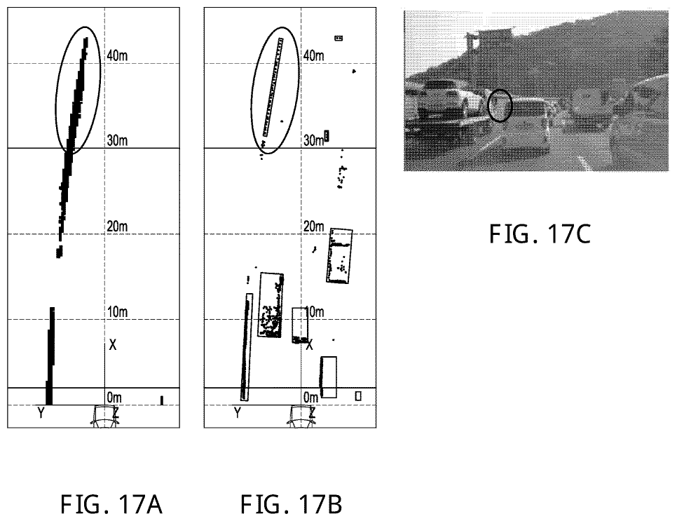

Referring to FIGS. 17A, 17B, and 17C, a guardrail that is hidden by a nearby vehicle and is thus cut off may be misrecognized as a dynamic object as it moves at a constant speed and in a constant direction along with the vehicle.

FIG. 17A shows a final data grid map, FIG. 17B shows a matching between track data and the final data grid map, and FIG. 17C shows a real captured image.

As shown in FIGS. 17A and 17B, the object tracking unit may generate a data grid map of an object (e.g., a cut guardrail) through points at a high position and determine the object (cut guardrail) as a static object using the generated grid map.

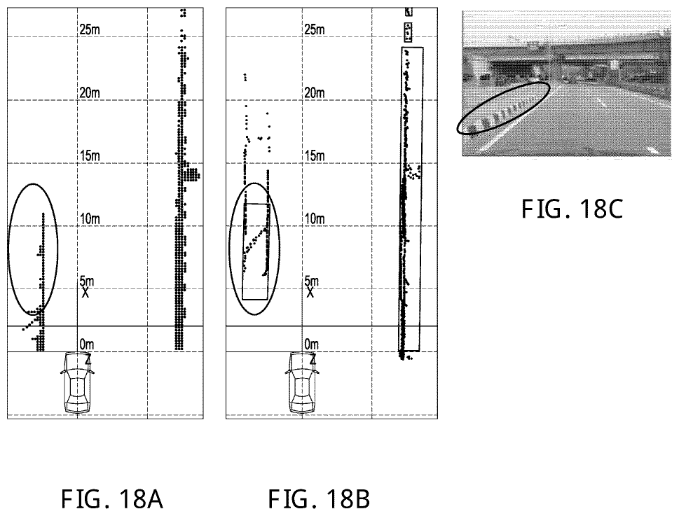

Referring to FIGS. 18A, 18B, and 18C, as the ground is removed, the shape of a curb-shaped median strip may not be maintained properly, on a mounting position of the lidar sensor. In particular, at a sensor FOV boundary, the ground is removed, and the median strip may be misrecognized as a dynamic object that moves at the same speed and in the same direction as a host vehicle around the host vehicle, as shown on a left side of the image.

FIG. 18A shows a final data grid map, FIG. 18B shows a matching track data and the final data grid map, and FIG. 18C shows a real captured image.

As shown in FIGS. 18A and 18B, the object tracking unit may generate a data grid map of an object (e.g., a curb-shaped median strip) through points at a high position and determine the object (the median strip) as a static object using the generated grid map.

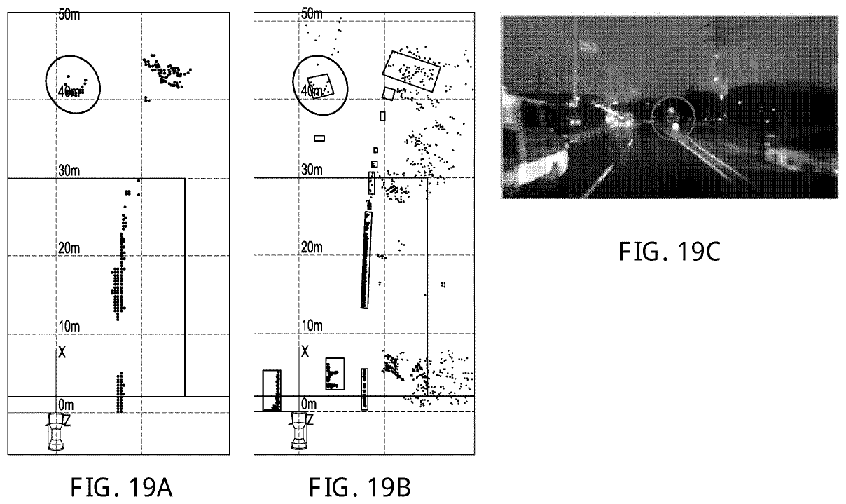

Referring to FIGS. 19A, 19B, and 19C, an L-shape highway shock absorption facility present inside a road boundary may be misrecognized as a dynamic object.

FIG. 19A shows a final data grid map, FIG. 19B shows a matching between track data and the final data grid map, and FIG. 19C shows a real captured image.

As shown in FIGS. 19A and 19B, the object tracking unit may generate a data grid map of an object (e.g., a highway shock absorption facility) through points at a high position and determine the object (highway shock absorption facility) as a static object using the generated grid map.

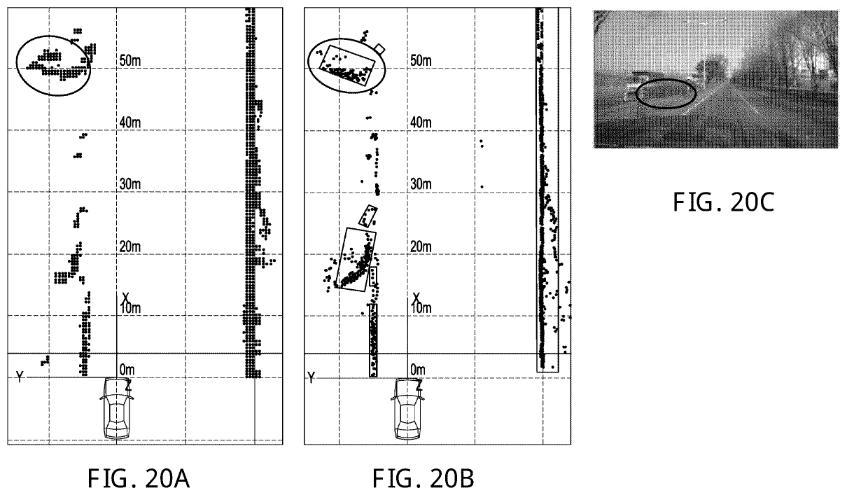

Referring to FIGS. 20A, 20B, and 20C, a portion of an L-shape central flower bed on a highway having a similar shape to a vehicle without a road boundary may be determined as a dynamic object.

FIG. 20A shows a final data grid map, FIG. 20B shows a matching between track data and the final data grid map, and FIG. 20C shows a real captured image.

As shown in FIGS. 20A and 20B, the object tracking unit may generate a data grid map of an object (e.g., a central flower bed on a highway) through points at a high position and determine the object (central flower bed) as a static object using the generated grid map.

As described above, the object tracking apparatus and method according to embodiments of the present disclosure may employ lidar-based static object determination technology using a data grid map and improve system performance degradation that may be caused by misrecognition of bushes/trees and the like as a dynamic object.

In addition, the object tracking apparatus and method according to embodiments of the present disclosure may prevent an issue in which a guardrail hidden by a nearby vehicle moves at a constant speed as the vehicle and is thus erroneously determined as a dynamic object.

In addition, the object tracking apparatus and method according to embodiments of the present disclosure may quickly determine even a cut guardrail as a static object, thereby improving the performance in terms of positioning.

On the other hand, a recording medium in which a program for executing the object tracking method is recorded may record a program implementing functions, and a computer may read the recording medium.

The computer-readable medium includes all types of recording devices in which data readable by a computer system is stored. Examples of the computer-readable medium include a read-only memory (ROM), a random-access memory (RAM), a CD-ROM, a magnetic tape, a floppy disk, an optical data storage device, and the like. In addition, the computer-readable recording medium is distributed to computer systems connected through a network so that computer-readable codes may be stored and executed in a distributed manner. Also, functional programs, codes, and code segments for implementing the method may be easily inferred by programmers in the technical field to which the present disclosure pertains.

Various embodiments described herein may be combined without departing from the objectives of the present disclosure and contradicting each other. In addition, among the various embodiments, when components of one embodiment are not described in detail, descriptions of components having the same reference numerals in other embodiments may be applied.

Although the present disclosure has been described with reference to the embodiments, it is understood by one of ordinary skill in the art that changes, modifications, or applications may be made without departing from the spirit and scope of the claims and their equivalents. For example, each component specifically shown in the embodiments may be modified and implemented, and differences related to these modifications and applications should be construed as being included in the scope of the present disclosure as defined in the appended claims.

What is claimed is:

1. An object tracking apparatus comprising:
a light detection and ranging (lidar) sensor; and
one or more processors; and
memory storing instructions that, when executed by the one or more processors, cause the object tracking apparatus to:
receive lidar data from the lidar sensor and track an object using the received lidar data;
determine, based on a predetermined criterion and information about the object, at least one of:
a first score indicating a likelihood that the object is moving, or
a second score indicating a likelihood that the object is stationary;
output a comparison result value of a comparison between the first score and the second score; and
determine, based on the comparison result value, whether the object is moving or stationary.

2. The object tracking apparatus of claim 1, wherein the instructions, when executed by the one or more processors, further cause the object tracking apparatus to:
generate at least one grid map to determine whether the object is moving or stationary, and generate a data grid map using the generated at least one grid map.

3. The object tracking apparatus of claim 2, wherein the instructions, when executed by the one or more processors, further cause the object tracking apparatus to:
match track data of the object with the data grid map; and
analyze grid information of at least one grid overlapped with at least one object in a matching map of the track data and the data grid map to determine whether the object is stationary.

4. The object tracking apparatus of claim 3, wherein the instructions, when executed by the one or more processors, further cause the object tracking apparatus:
based on the analyzed grid information being associated with a value greater than a threshold value, determine that the object is stationary.

5. The object tracking apparatus of claim 2, wherein the at least one grid map comprises a first grid map, a second grid map, and a third grid map, and
wherein the instructions, when executed by the one or more processors, further cause the object tracking apparatus to:
generate the first grid map using points at a position higher than a predetermined position for determining that the object is stationary;
generate the second grid map using lidar point information of the object determined to be stationary; and
generate the third grid map using lidar point information of the object determined to be moving.

6. The object tracking apparatus of claim 5, wherein the instructions, when executed by the one or more processors, further cause the object tracking apparatus to:
generate the data grid map by multiplying or inversely multiplying the first grid map, the second grid map, and the third grid map by weights.

7. The object tracking apparatus of claim 6, wherein the instructions, when executed by the one or more processors, further cause the object tracking apparatus to:
generate a first data grid map of a current frame by:
multiplying a second data grid map of a previous frame by a first weight to yield a first value;
multiplying the first grid map by a second weight to yield a second value;
multiplying the second grid map by a third weight to yield a third value; and
inversely multiplying the third grid map by a sum of the first value, the second value, and the third value.

8. The object tracking apparatus of claim 1, wherein the instructions, when executed by the one or more processors, further cause the object tracking apparatus to:
analyze a shape of the object by aligning vertex grids of the object in a lateral direction and calculating grids, of the object, ranging from a minimum lateral grid to a maximum lateral grid.

9. The object tracking apparatus of claim 1, wherein the instructions, when executed by the one or more processors, further cause the object tracking apparatus to:
classify, based on vertices of a shape of the object, the shape of the object into a first type, a second type, a third type, or a fourth type.

10. The object tracking apparatus of claim 1, wherein the instructions, when executed by the one or more processors, further cause the object tracking apparatus to:
classify, based on vertices of a shape of the object, the shape of the object into a first type, a second type, a third type, or a fourth type; and
divide each of the first type, the second type, the third type, and the fourth type into at least one area.

11. A method comprising:
receiving, from a light detection and ranging (lidar) sensor, lidar data associated with an object;
determining, based on a predetermined criterion and the lidar data, at least one of:
a first score indicating a likelihood that the object is moving, or
a second score indicating a likelihood that the object is stationary;
outputting a comparison result value of a comparison between the first score and the second score; and
determining, based on the comparison result value, whether the object is moving or stationary.

12. The method of claim 11, further comprising:
generating at least one grid map to determine whether the object is moving or stationary, and generating a data grid map using the generated at least one grid map.

13. The method of claim 12, further comprising:
matching track data of the object with the data grid map; and
analyzing grid information of at least one grid overlapped with at least one object in a matching map of the track data and the data grid map to determine whether the object is stationary.

14. The method of claim 13, further comprising:
based on the analyzed grid information being associated with a value greater than a threshold value, determining that the object is stationary.

15. The method of claim 12, wherein the at least one grid map comprises a first grid map, a second grid map, and a third grid map, and
wherein the method further comprises:
generating the first grid map using points at a position higher than a predetermined position for determining that the object is stationary;
generating the second grid map using lidar point information of the object determined to be stationary; and
generating the third grid map using lidar point information of the object determined to be moving.

16. The method of claim 15, further comprising:
generating the data grid map by multiplying or inversely multiplying the first grid map, the second grid map, and the third grid map by weights.

17. The method of claim 16, further comprising:
generating a first data grid map of a current frame by:
multiplying a second data grid map of a previous frame by a first weight to yield a first value;
multiplying the first grid map by a second weight to yield a second value;
multiplying the second grid map by a third weight to yield a third value; and
inversely multiplying the third grid map by a sum of the first value, the second value, and the third value.

18. The method of claim 11, further comprising:
analyzing a shape of the object by aligning vertex grids of the object in a lateral direction and calculating grids, of the object, ranging from a minimum lateral grid to a maximum lateral grid.

19. The method of claim 11, further comprising:
classifying, based on vertices of a shape of the object, the shape of the object into a first type, a second type, a third type, or a fourth type.

20. The method of claim 11, further comprising:
classifying, based on vertices of a shape of the object, the shape of the object into a first type, a second type, a third type, or a fourth type; and
dividing each of the first type, the second type, the third type, and the fourth type into at least one area.
